(19) United States
(12) Patent Application Publication
(10) Pub. No.: US 2018/0321490 A1
(43) Pub. Date: Nov. 8, 2018

(54) HEAD UP DISPLAY WITH FACETTED WINDSHIELD

(71) Applicant: Panasonic Automotive Systems Company of America, Division of Panasonic Corporation of North America, PEACHTREE CITY, GA (US)

(72) Inventors: DAVID KAY LAMBERT, STERLING HEIGHTS, MI (US); WALTER JOSEPH NILL, DAVISON, MI (US); PETER CLARENCE SOHLDEN, SHELBY TOWNSHIP, MI (US)

(73) Assignee: Panasonic Automotive Systems Company of America, Division of Panasonic Corporation of North America

(21) Appl. No.: 15/968,075

(22) Filed: May 1, 2018

Related U.S. Application Data
(60) Provisional application No. 62/500,040, filed on May 2, 2017.

(51) Int. Cl. G02B 27/01; B60R 1/00

(52) U.S. Cl. CPC G02B 27/0101; B60R 1/00; B60R 2300/8093; B60R 2300/205; B60R 2300/8066; G02B 2027/013

(57) ABSTRACT

A motor vehicle includes a windshield having a plastic layer sandwiched between two glass layers. The plastic layer has a partially reflective element therein. The partially reflective element passes a first portion of light received from a first direction and reflects a remainder of the light in a second direction. A projection arrangement projects a light field onto the partially reflective element such that a reflected portion of the light field is visible to a driver of the motor vehicle as a virtual image.

### CROSS-REFERENCED TO RELATED APPLICATIONS

This application claims benefit of U.S. Provisional Application No. 62/500,040 filed on May 2, 2017, which the disclosure of which is hereby incorporated by reference in its entirety for all purposes.

### FIELD OF THE INVENTION

The disclosure relates to a display system for a motor vehicle, and, more particularly, to a head up display system for a motor vehicle.

### BACKGROUND OF THE INVENTION

Many automotive HUDs fall into one of two categories: windshield HUDs, where the projector is below the dash and the projected light is reflected from the windshield to be seen by the driver as a virtual image outside the windshield; and combiner HUDs, where the projector is mounted above the dash, and the transparent combiner through which the driver sees a virtual image is separate from the windshield. For styling purposes, there is reason to prefer a windshield HUD since the projector is hidden and there is not a separate combiner. The absence of a projector and combiner above the dash may also help meet safety requirements. However, the conventional shapes of some vehicle windshields do not allow a conventional windshield HUD to be implemented. For example, trains and buses often have large flat windshields. Race cars often have windshields with a low rake angle.

Conventional windshield HUDs utilize reflection from the front and back surfaces of the windshield. Such HUDs require the HUD projector to be located below the dash in a specific location. Some vehicles have windshields that do not allow a windshield HUD to be implemented. More package volume may be required than is available. An increase in the field of view of the HUD image increases the package volume required for the HUD projector.

Conventional windshield HUD packages often require more volume beneath the dashboard than is available. The required volume increases as the field of view increases. For a conventional windshield HUD, the HUD projector must be under the dash surface, where a ray from the driver's eye to the virtual image reflects from the windshield down to the dash. Typically, this location is close to the steering column.

Combiner HUDs are separate units, with a transparent combiner other than the windshield. However, combiner HUDs introduce styling issues and may make it more difficult to meet head-impact safety regulations.

HUDs that use a diffractive combiner in or on the windshield appear to have many of the same benefits as the present invention. However, when the sun shines on the diffractive combiner, it creates an effect in which the sunlight is separated into its various colors. The resulting artifact is distracting to the driver for particular directions of the sun relative to the vehicle. Because the present invention does not use diffraction, there is no such effect with the present invention.

### SUMMARY

The present invention may provide a windshield head up display (HUD) in a motor vehicle including partially reflective facets in or near a windshield. The partially reflective facets may direct light from a projector to a person's eyes, to be seen as a virtual image outside of the windshield.

HUD systems that use an array of microlenses on or in the windshield are superficially similar to the present invention in that such a system can be designed so that light from a small projector is seen by the driver. However, the faceted reflector according to the current invention directs the reflected light in a specific direction (typically not the direction light reflects from the windshield surface), while a microlens array spreads transmitted light into a range of angles.

In one embodiment, the invention comprises a motor vehicle including a windshield having a plastic layer sandwiched between two glass layers. The plastic layer has a partially reflective element therein. The partially reflective element passes a first portion of light received from a first direction and reflects a remainder of the light in a second direction. A projection arrangement projects a light field onto the partially reflective element such that a reflected portion of the light field is visible to a driver of the motor vehicle as a virtual image.

In another embodiment, the invention comprises a motor vehicle including a windshield having a glass layer with an outer surface and an inner surface. A plastic layer is attached to the inner surface of the glass layer. The plastic layer has a partially reflective element therein. The partially reflective element passes a first portion of light received from a first direction and reflects a remainder of the light in a second direction. A projection arrangement projects a light field onto the partially reflective element such that a reflected portion of the light field is visible to a driver of the motor vehicle as a virtual image.

In yet another embodiment, the invention comprises a motor vehicle including a windshield having a glass layer with an outer surface and an inner surface. A plastic layer is attached to the outer surface of the glass layer. The plastic layer has a partially reflective element therein. The partially reflective element passes a first portion of light received from a first direction and reflects a remainder of the light in a second direction. A projection arrangement projects a light field onto the partially reflective element such that a reflected portion of the light field is visible to a driver of the motor vehicle as a virtual image.

An advantage of the invention makes it possible for a HUD to be used with any windshield, regardless of the windshield's size or angle of orientation.

Another advantage is that it may provide a HUD system with a smaller package size for a given field of view, or a bigger field of view for a given package size.

Yet another advantage is that there are more locations at which the HUD projector can be installed.

### BRIEF DESCRIPTION OF THE DRAWINGS

A better understanding of the present invention will be had upon reference to the following description in conjunction with the accompanying drawings.

FIG. 1 is a block diagram of one embodiment of a head up display arrangement of the present invention.

FIG. 2 is a block diagram of another embodiment of a head up display arrangement of the present invention.

FIG. 3 is an overhead view of locations of the partially reflective facets and the video camera of the head up display arrangement of FIG. 2.

### DETAILED DESCRIPTION OF THE PREFERRED EMBODIMENTS

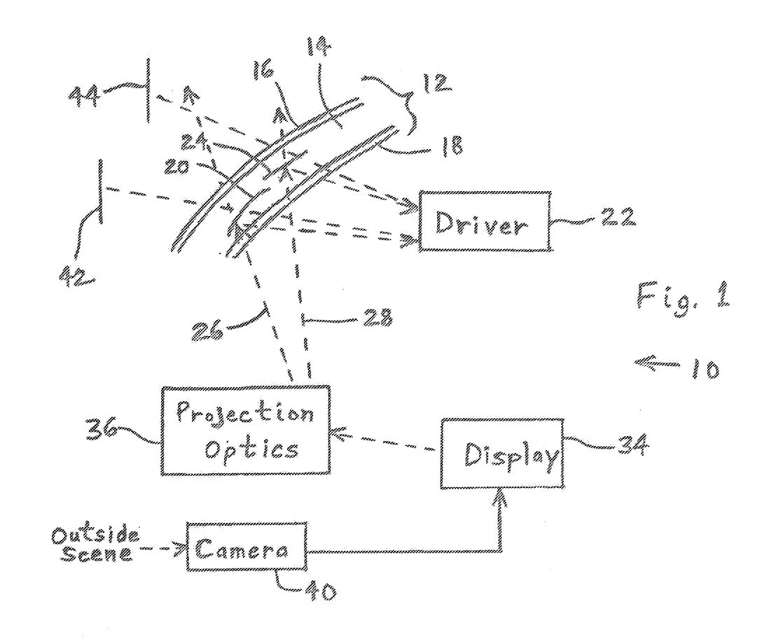

FIG. 1 illustrates one embodiment of a head up display arrangement 10 of the present invention, including a front windshield 12, a video camera 40, a display screen 34, and projection optics 36 creating virtual images 42, 44 which appear to a human driver 22 to be disposed outside of windshield 12. Windshield 12 includes a layer 14 of plastic (polymer) sandwiched between an outer glass layer 16 and an inner glass layer 18. Embedded in plastic layer 14 are partially reflective elements, which may have partially reflective facets 20, 24. Light fields 26, 28 are reflected by facets 20, 24, respectively, so as to be seen by driver as virtual images 42, 44, respectively.

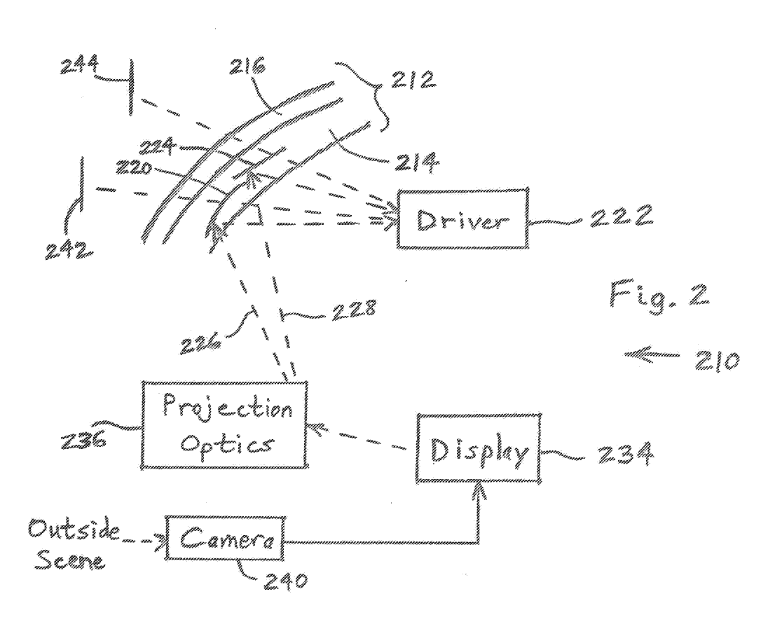

FIG. 2 illustrates another embodiment of a head up display arrangement 210 of the present invention, including a front windshield 212, a video camera 240, a display screen 234, and projection optics 236 creating virtual images 242, 244 which appear to a human driver 222 to be disposed outside of windshield 212. Windshield 212 includes a layer 214 of plastic (polymer) attached to an inner surface of a glass layer 216. Embedded in plastic layer 214 are partially reflective elements, which may have partially reflective facets 220, 224. Light fields 226, 228 are reflected by facets 220, 224, respectively, so as to be seen by driver as virtual images 242, 244, respectively. It is possible for the plastic layer to be attached to an outer surface of the glass layer rather than to the inner surface of the glass layer.

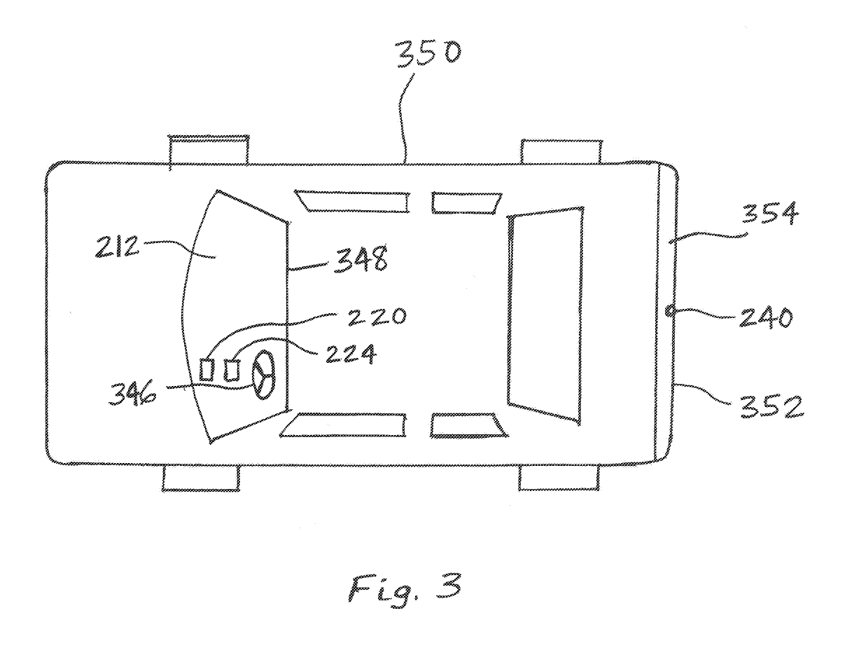

FIG. 3 illustrates locations of partially reflective facets 220, 224 and video camera 240 of head up display arrangement 210 of FIG. 2. Reflective facets 220, 224 may be disposed within windshield 212 approximately between a steering wheel 346 at a midpoint of a top edge 348 of windshield 212 of motor vehicle 350. Video camera 240 may be attached to a rear end 352 of motor vehicle 350, such as on a rear bumper 354 of vehicle 350.

This invention is not limited so the HUD only displays a video image of a scene. As is known to the art, the image displayed to the driver may include text information, icons, symbols, or diagrams. The information displayed may include information such as vehicle speed, warning icons, navigation cues, and vehicle status. The information displayed may also be related to the scene viewed by the driver through the windshield, commonly known as augmented reality or a contact analog display, and the displayed virtual image may related to the driver's view of nearby objects.

The use of separate reflective surfaces for imaging, such as the facets, instead of the inner and outer surfaces of the glass as used in the prior art, may provide extra freedom and flexibility to optical designs incorporating the present invention. The extra freedom and flexibility may enable one or more of the following: implementing a windshield HUD in vehicles in which this would otherwise be impossible because of the shape of the windshield; reducing the package volume of the HUD projector; placing the HUD projector in locations under or around the dash where it would not be possible if the light were simply reflected from the windshield surface; and increasing the field of view of the HUD image that can be seen by the driver for a given package volume of the HUD projector.

One way to implement this invention is to use optical design software such as Zemax to create multiple optical designs for HUDs, each with a combiner, that step the distance from the driver's eye to the combiner. The combiners in all the designs may fill the volume of space to be occupied by the portion of the windshield that is to be used to reflect light from the projector to the driver to be seen as a virtual image. The intersection of the sequence of combiners with the volume to be occupied by the partially reflective facets may be determined. The combiners may need to be spaced close enough together to prevent noticeable gaps between the facets.

The partially reflecting surfaces can be created by: (1) using the optical design to fabricate a metal surface with the facets; (2) injection molding plastic to fabricate a transparent plastic part with the facets; or (3) over-molding with another polymer having a different index of refraction so the facets have the desired reflectivity. A coating of one or more films of controlled thickness may be deposited on the facets in order to enhance the reflectivity. The coating material may be one or more films of a metal, a metal oxide, a ceramic, and/or a polymer.

In one embodiment, the driver sees light reflecting from multiple facets along the line of sight. Optionally, the reflectivity of a facet may vary as a function of position, to avoid the perception of an edge to individual facets.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detail description is given primarily for clearness of understanding and no unnecessary limitations are to be understood therefrom for modifications can be made by those skilled in the art upon reading this disclosure and may be made without departing from the spirit of the invention.

What is claimed is:

1. A motor vehicle, comprising:
a windshield including a plastic layer sandwiched between two glass layers, the plastic layer having a partially reflective element therein, said partially reflective element being configured to pass a first portion of light received from a first direction and reflect a remainder of the light in a second direction; and
a projection arrangement configured to project a light field onto the partially reflective element such that a reflected portion of the light field is visible to a driver of the motor vehicle as a virtual image.

2. The motor vehicle of claim 1, wherein the virtual image appears to the driver to be at least two meters away from the driver.

3. The motor vehicle of claim 1, wherein the second direction in which the partially reflective element reflects a remainder of the light field is different from a third direction in which a surface of one of the glass layers would reflect the remainder of the light field.

4. The motor vehicle of claim 1, wherein the plastic layer has a plurality of partially reflective elements therein.

5. The motor vehicle of claim 4, wherein each of the partially reflective elements is configured to reflect a portion of a respective light field such that the reflected portion of the light field is visible to the driver as a respective virtual image.

6. The motor vehicle of claim 1, wherein the partially reflective element has a flat partially reflective facet.

7. The motor vehicle of claim 1, wherein the partially reflective element has a concavely curved partially reflective facet.

8. A motor vehicle, comprising:
a windshield including:
a glass layer having an outer surface and an inner surface; and
a plastic layer attached to the inner surface of the glass layer, the plastic layer having a partially reflective element therein, said partially reflective element being configured to pass a first portion of light received from a first direction and reflect a remainder of the light in a second direction; and
a projection arrangement configured to project a light field onto the partially reflective element such that a reflected portion of the light field is visible to a driver of the motor vehicle as a virtual image.

9. The motor vehicle of claim 8, wherein the virtual image appears to the driver to be at least two meters away from the driver.

10. The motor vehicle of claim 8, wherein the second direction in which the partially reflective element reflects a remainder of the light field is different from a third direction in which a surface of the glass layer would reflect the remainder of the light field.

11. The motor vehicle of claim 8, wherein the plastic layer has a plurality of partially reflective elements therein.

12. The motor vehicle of claim 11, wherein each of the partially reflective elements is configured to reflect a portion of a respective light field such that the reflected portion of the light field is visible to the driver as a respective virtual image.

13. The motor vehicle of claim 8, wherein the partially reflective element has a flat partially reflective facet.

14. The motor vehicle of claim 8, wherein the partially reflective element has a concavely curved partially reflective facet.

15. A motor vehicle, comprising:
a windshield including:
a glass layer having an outer surface and an inner surface; and
a plastic layer attached to the outer surface of the glass layer, the plastic layer having a partially reflective element therein, said partially reflective element being configured to pass a first portion of light received from a first direction and reflect a remainder of the light in a second direction; and
a projection arrangement configured to project a light field onto the partially reflective element such that a reflected portion of the light field is visible to a driver of the motor vehicle as a virtual image.

16. The motor vehicle of claim 15, wherein the virtual image appears to the driver to be at least two meters away from the driver.

17. The motor vehicle of claim 15, wherein the second direction in which the partially reflective element reflects a remainder of the light field is different from a third direction in which a surface of the glass layer would reflect the remainder of the light field.

18. The motor vehicle of claim 15, wherein the plastic layer has a plurality of partially reflective elements therein.

19. The motor vehicle of claim 18, wherein each of the partially reflective elements is configured to reflect a portion of a respective light field such that the reflected portion of the light field is visible to the driver as a respective virtual image.

20. The motor vehicle of claim 15, wherein the partially reflective element has a flat partially reflective facet.

21. The motor vehicle of claim 15, wherein the partially reflective element has a concavely curved partially reflective facet.
